(19) United States
(12) Patent Application Publication
(10) Pub. No.: US 2012/0082330 A1
(43) Pub. Date: Apr. 5, 2012

(54) METHOD FOR SIGNAL PROCESSING IN A HEARING AID AND HEARING AID

(75) Inventors: Ulrich Kornagel, Erlangen (DE); Matthias Latzel, Eggolsheim (DE); Stefan Petrausch, Erlangen (DE); Andreas Tiefenau, Zaandam (NL)

(73) Assignee: SIEMENS MEDICAL INSTRUMENTS PTE. LTD., Singapore (SG)

(21) Appl. No.: 13/249,528

(22) Filed: Sep. 30, 2011

(30) Foreign Application Priority Data
Sep. 30, 2010 (DE) 10 2010 041 740.8

(51) Int. Cl. H04R 25/00

(52) U.S. Cl. 381/320

(57) ABSTRACT

A hearing aid is enabled for dynamic compression in a way to further improve the perception of acoustic signals in the provision of hearing assistance to a hearing-impaired person. Here, an input signal is divided into a plurality of frequency bands. Input-level-controlled dynamic compression is performed in at least one first frequency band and output-level-controlled dynamic compression is performed in at least one second frequency band. This optimizes both loudness perception and speech intelligibility.

### CROSS-REFERENCE TO RELATED APPLICATION

This application claims the priority, under 35 U.S.C. §119, of German patent application DE 10 2010 041 740.8, filed Sep. 30, 2010; the prior application is herewith incorporated by reference in its entirety.

### BACKGROUND OF THE INVENTION

### Field of the Invention

The invention relates to a method for signal processing in a hearing aid and to a hearing aid in which an input signal is subdivided into a plurality of frequency bands.

It is established practice in hearing aids to use dynamic compression in order to compensate for a user's hearing loss, in particular when a recruitment is present. The real acoustic environment is mapped into the residual dynamic range of the hearing-impaired user by means of the dynamic compression. In such cases the residual dynamic range is defined by the user's hearing threshold and threshold of discomfort. The residual dynamic range is frequency-dependent.

The mapping of the real acoustic environment onto the residual dynamic range of the hearing-impaired person is accomplished by means of automatic gain control (AGC). The use of output-level-controlled automatic gain control (AGCO) and input-level-controlled automatic gain control (AGCI) are well-known in this context.

As an example of output-level-controlled dynamic compression, reference is had to U.S. Pat. No. 6,731,767 B1 and its counterpart international publication No. WO 00/47014, which describe a so-called Adaptive Dynamic Range Optimization (ADRO) compression. With that approach the output level is used for controlling the amplification, and moreover not simply for level limiting but also for (slow) compression across the entire dynamic range, an attempt being made in the process to apply a linear gain and its advantages in respect of sound and speech intelligibility against background noise.

The use of output-level-controlled and input-level-controlled dynamic compression in a hearing aid is described in the commonly assigned patent application publication No. US 2007/0140512 A1 and its counterpart German published patent application DE 10 2005 061 000 A1. Switching between the different dynamic compression algorithms is effected on the basis of the assignment of the input signal entering the respective hearing aid to a specific hearing environment (classification).

Commonly assigned patent application publication No. US 2007/0053535 A1 and its counterpart German published patent application DE 10 2009 004 185 A1 describe the simultaneous use of both output-level-controlled dynamic compression and input-level-controlled dynamic compression in a hearing aid, wherein the different dynamic compression modes are performed in two parallel signal paths and the two signal paths are merged using weighting that is dependent on the classification.

Extensive studies carried out with the different types of dynamic compression have revealed that it makes sense to give precedence to one of the two compression modes in certain hearing situations. The choice made or weighting applied can be determined e.g. on the basis of a classification system which decides in which acoustic hearing environment the hearing aid is currently situated. Thus, output-level-controlled dynamic compression (AGCO), e.g. ADRO (Adaptive Dynamic Range Optimization) compression, is preferred, for instance in a very loud hearing environment. If, on the other hand, a hearing situation is detected in which a strong voice signal is present, then input-level-controlled dynamic compression (AGCI), e.g. WDRC (Wide Dynamic Range Compression) compression, is preferred. The studies mentioned have shown in particular that the type of compression has an effect on the perception of a specific input signal. Thus, in ADRO compression, for example, a significant impact on the perception of loudness is evident, while WDRC compression improves the perception of speech. It is therefore advantageous to perform the dynamic compression as a function of the classification.

### SUMMARY OF THE INVENTION

It is accordingly an object of the invention to provide a hearing aid and a signal processing method which overcome the above-mentioned disadvantages of the heretofore-known devices and methods of this general type and which provides for a further improvement in the perception of acoustic signals in the provision of hearing assistance by way of a hearing aid.

With the foregoing and other objects in view there is provided, in accordance with the invention, a method for signal processing in a hearing aid, the method which comprises the following steps:

receiving an input signal and dividing the input signal into a plurality of frequency bands;

performing input-level-controlled dynamic compression in at least one first frequency band of the plurality of frequency bands;

performing output-level-controlled dynamic compression in at least one second frequency band of the plurality of frequency bands; and outputting an output signal.

The invention initially makes provision for an acoustic input signal to be subdivided into a plurality of frequency bands (channels). In principle this can also entail a very large number of frequency bands, as results for example in the digital transformation of the input signal from the time domain into the frequency domain, by way of a digital FFT (fast Fourier transform) for example. Usually, however, the acoustic input signal is subdivided into a manageable number of frequency bands (e.g. 16) by means of a filter bank. According to the invention input-level-controlled dynamic compression (AGCI) now takes place in at least one of the generated frequency bands and simultaneously output-level-controlled dynamic compression (AGCO) is performed in at least one other frequency band. For example, output-level-controlled compression (AGCO) can be used in at least one frequency band in the low frequency range of the acoustic input signal, since low frequencies have a significant effect on the perception of loudness, which means that a form of compression that positively influences the loudness perception is advantageous in the low frequency range. In the upper frequency range, on the other hand, input-level-controlled compression is advantageously used, since this frequency range is more dominant with regard to speech intelligibility and input-level-controlled compression (AGCI) has an advantageous effect on speech intelligibility. However, in the case of a hearing aid according to the invention it is advantageously possible to assign any type of compression to each channel.

In accordance with an added feature of the invention, the signal path in at least one frequency band is subdivided into at least two parallel signal paths. In this case input-level-controlled dynamic compression (AGCI) is performed in a first signal path within the respective frequency band and output-level-controlled dynamic compression (AGCO) is performed in a second signal path of the respective frequency band before the signal paths are merged once more. This has the advantage that it is possible to switch between the different compression types in the respective frequency band, and moreover independently of the compression type chosen in another frequency band. This enables the signal processing of the hearing aid to be adapted more effectively to different hearing situations.

In a further embodiment variant of the invention in which the signal processing is performed in at least two parallel signal paths in at least one frequency band, no switching takes place between the individual signal paths, but instead, following the respective execution of different types of dynamic compression, the signal paths are merged in a specific mixing ratio, i.e. using different weightings. This permits the signal processing in the respective hearing aid to be adapted even more effectively to different hearing situations. The system described would basically no longer require a classification, since the signal processing is constantly operated with input-level-controlled and output-level-controlled dynamic compression. The different compression methods could, however, also be activated and deactivated automatically in a frequency-dependent manner as a function of the classification or be linked to one another with a different weighting in the respective frequency band. This switching or mixing is advantageously performed not only on the basis of the classification, which tends to take physical variables into account, but also with the inclusion of psychoacoustic variables.

All in all the invention offers the advantage that a hearing aid according to the invention operates in a frequency-specific manner also in relation to the dynamic compression. Thus, the advantages of input- and output-related gain control can be exploited simultaneously in a specific acoustic situation.

In a preferred embodiment variant of the invention the input-level-controlled dynamic compression (AGCI) is performed as WDRC (Wide Dynamic Range Compression) compression. In an advantageous embodiment variant of the invention the output-level-controlled compression (AGCO) is furthermore performed as ADRO (Adaptive Dynamic Range Optimization) compression.

The assignment of the different compression methods to the individual frequency bands or to the individual signal paths within the individual frequency bands can advantageously be specified by programming of a respective hearing aid, by a hearing aid acoustician for example. Furthermore, in a hearing aid having a plurality of parallel signal paths within one frequency band, in which signal paths different types of dynamic compression are performed, the mixing ratio between the individual signal paths is advantageously also adjustable by means of programming. In this case the ratio is preferably also set as a function of the individual hearing loss of the user.

In a particularly advantageous embodiment variant of the invention the assignment of the different compression methods to the individual frequency bands as well as where appropriate also the mixing ratio of the parallel signal paths within a frequency band can change in the course of the ongoing operation of a respective hearing aid. The setting is advantageously carried out adaptively as a function of the current hearing situation in which the hearing aid is being operated and which is established with the aid of a classifier.

With the above and other objects in view there is also provided, in accordance with the invention, a hearing aid that is specifically configured for carrying out the above-summarized method. The apparatus comprises:

an input transducer for acquiring an acoustic input signal and converting the input signal into an electrical input signal;

a filter bank for dividing the electrical input signal into a plurality of frequency bands;

means for performing output-level-controlled dynamic compression in at least one first frequency band of the plurality of frequency bands;

means for performing input-level-controlled dynamic compression in at least one second frequency band of the plurality of frequency bands;

a merging device for merging output signals of the individual frequency bands into an overall electrical output signal; and

an output converter for converting the overall electrical output signal into an output signal to be perceived as an acoustic output signal by a user.

Other features which are considered as characteristic for the invention are set forth in the appended claims.

Although the invention is illustrated and described herein as embodied in a method for signal processing in a hearing aid and hearing aid, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows the block diagram of a hearing aid using input-level-controlled dynamic compression;

FIG. 2 shows the block diagram of a hearing aid using output-level-controlled dynamic compression;

FIG. 3 shows the block diagram of a hearing aid using both input-level-controlled and output-level-controlled dynamic compression in two parallel signal paths;

FIG. 4 shows the block diagram of a hearing aid according to the invention;

FIG. 5 shows the block diagram of a further hearing aid according to the invention; and

FIG. 6 shows a flowchart for signal processing in a hearing aid according to the invention.

### DETAILED DESCRIPTION OF THE INVENTION

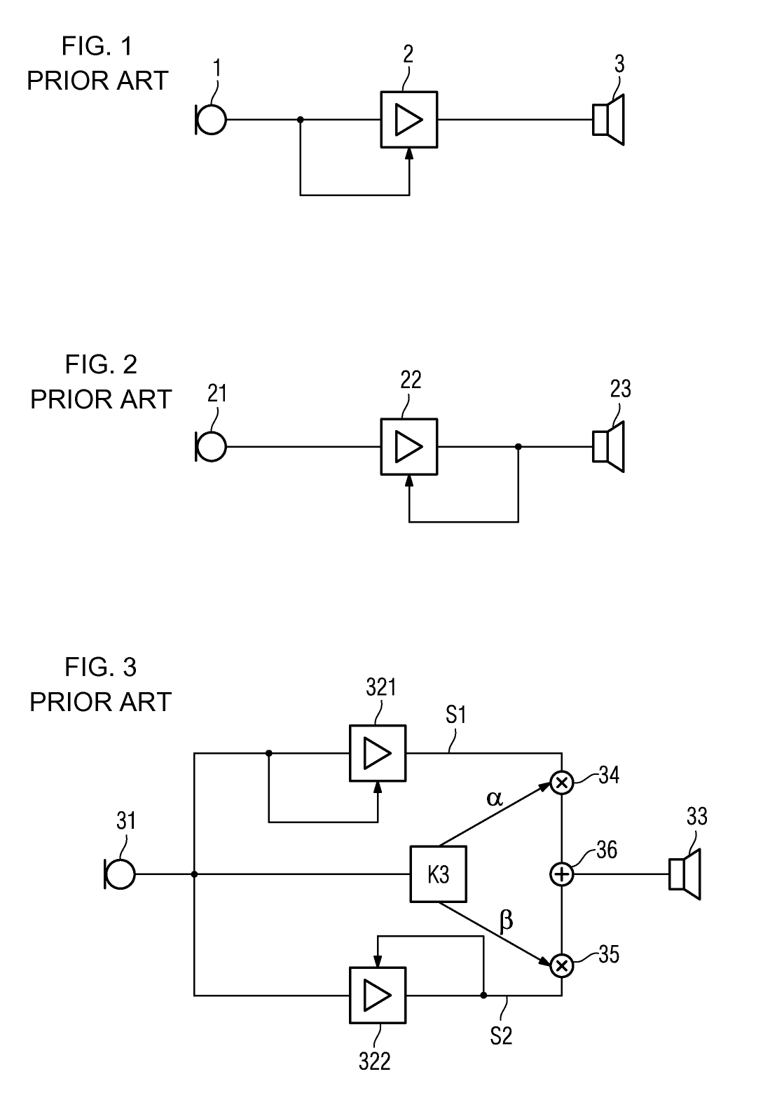

Referring now to the figures of the drawing in detail and first, particularly, to FIG. 1 thereof, there is shown a greatly simplified block diagram showing a hearing aid using input-level-controlled dynamic compression (AGCI) according to the prior art. In this case an acoustic input signal is recorded by a microphone 1, processed and amplified as a function of frequency in a signal processing unit 2 and finally supplied to an earpiece 3 for the purpose of generating an acoustic output signal. Input-level-controlled gain control (AGCI) is performed. Possible adjustable parameters are for example the compression rate, the amplification or a time constant of the control.

Analogously to FIG. 1, FIG. 2 also shows the block diagram of a hearing aid according to the prior art, comprising a microphone 21, a signal processing unit 22 and an earpiece 23. In this case, however, in contrast to FIG. 1, output-level-controlled dynamic compression (AGCO) is performed. Particularly advantageously a maximum output level can be set in the respective hearing aid in this instance.

A further block diagram of a hearing aid according to the prior art is shown in FIG. 3. In this embodiment variant the input signal being emitted by the microphone 31 is split such that the signal processing is performed in two parallel signal paths. In this case the signal S1 is generated in the first signal path by means of a first signal processing unit 321 using input-level-controlled dynamic compression and in the parallel second signal path the signal S2 is generated by means of a second signal processing unit 322 using output-level-controlled dynamic compression. The input signal is also supplied to a classifier K3 which analyzes the input signal and establishes the current hearing situation in which the hearing aid is being operated. Depending on the classification result weights α and β in the range of 0 to 1 are specified for the individual signal paths, the signals S1 and S2 of the signal paths being multiplied by said weights by means of the multipliers 34 and 35, respectively, before the signal paths are merged in the adder 36 and a signal is output via the earpiece 33.

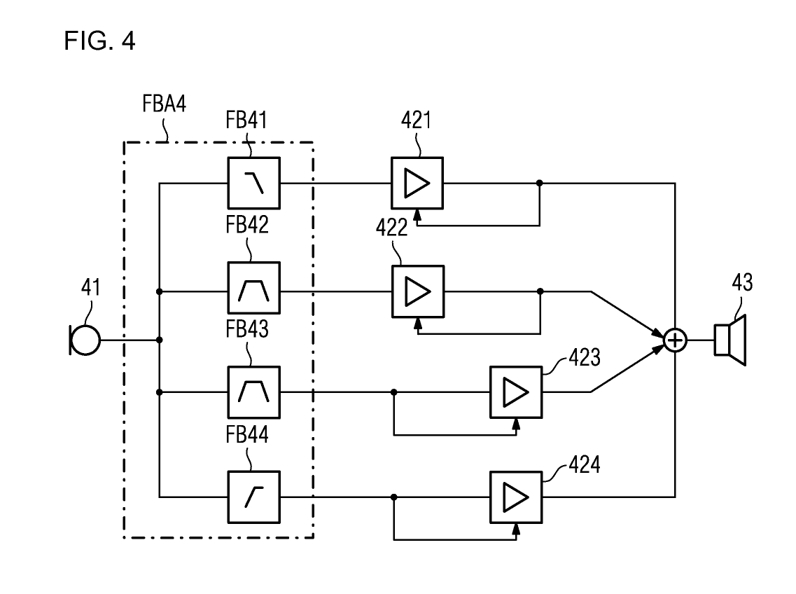

An exemplary block diagram of a hearing aid according to the invention is shown in FIG. 4. Here, the electrical input signal generated by the microphone 41 is first subdivided by way of a filter bank FBA4 into a plurality of frequency bands. In the exemplary embodiment these are a lower frequency band FB41, two mid frequency bands FB42 and FB43 and an upper frequency band FB44. According to the invention different types of compression are now chosen for different frequency bands. Thus, in the exemplary embodiment, output-level-controlled dynamic compression is specified for the lower frequency band FB41 and the first medium frequency band FB42, and input-level-controlled dynamic compression is specified for the second medium frequency band FB43 and for the upper frequency band FB44. This choice has a particularly advantageous effect both on loudness perception and on speech intelligibility for an acoustic input signal which is supplied to a user via the hearing aid.

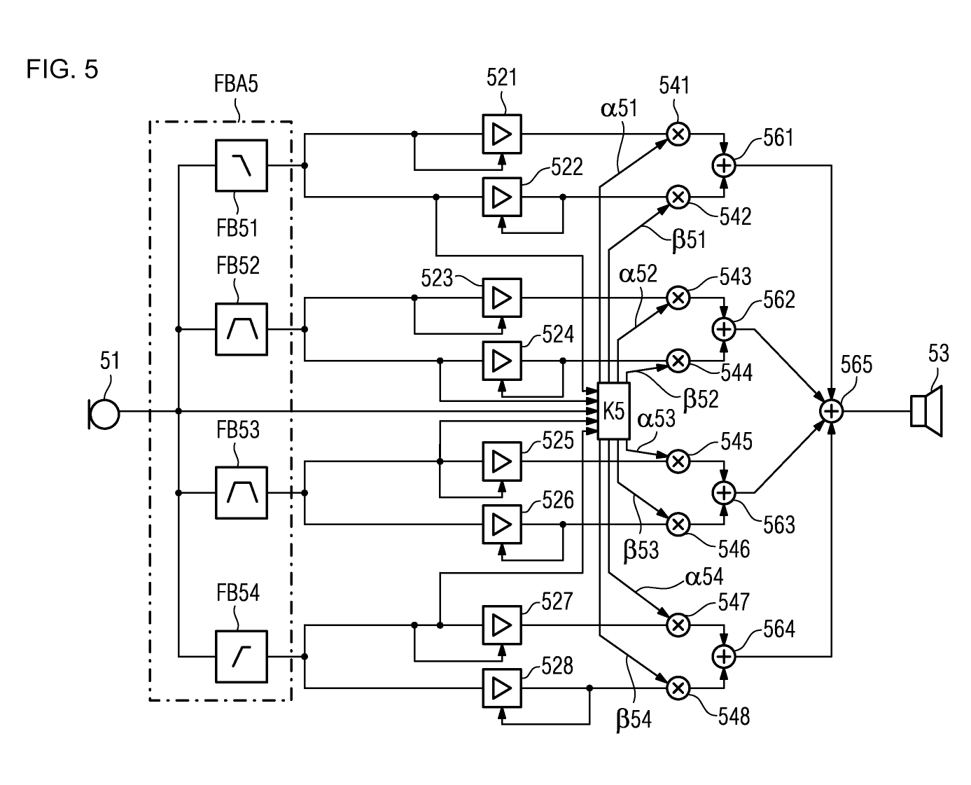

A particularly advantageous embodiment variant of the invention is shown in the block diagram according to FIG. 5. In contrast to the exemplary embodiment according to FIG. 4, in this instance the electrical output signals of the filter bank FBA5 are split for each frequency band into two parallel signal paths in each case. Here, input-level-controlled dynamic compression is provided in each case for one signal path and output-level-controlled dynamic compression for the other signal path. Specifically, for the frequency band FB51, input-level-controlled dynamic compression is performed in the signal processing unit 521 and output-level-controlled dynamic compression is performed in parallel in the signal processing unit 522. The two parallel signal paths of the frequency band FB51 are weighted differently through multiplication by the factors a51 and 1351 in the multipliers 541 and 542, respectively, and added in the adder 561. An analogous procedure is followed also for the further frequency bands FB52 to FB54. In this case each of the factors preferably lies in the range from 0 to 1. The factors can also be different between the individual frequency bands. Finally the resulting signals are added in the adder 565 and output via the earpiece 53.

If only the numerical values 0 or 1 are allowed for the factors, it is possible to switch between the different types of dynamic compression in each frequency band. Obviously a gradual transition is also possible here, in that no hard switchover between 0 and 1 is performed.

The individual weights of the signal paths can advantageously be set by programming the respective hearing aid. Preferably the weights are adjusted dynamically during the ongoing operation of the hearing aid. For this purpose the electrical input signal emitted by the microphone 51 and the output signals of the filter bank FBA5 are supplied and analyzed in the classification and control unit K5. The weights are then set accordingly as a function of the detected hearing situation. Thus, in the hearing situation “speech in noise”, for example, the weights are set such that the resulting signal processing by the hearing aid is performed according to the exemplary embodiment illustrated in FIG. 4. Both speech intelligibility and loudness perception are optimized in this way. Preferably the sum of the factors for each frequency band yields the value 1 so that the frequency bands are weighted equally with respect to one another. A different weighting of the frequency bands is also possible, however.

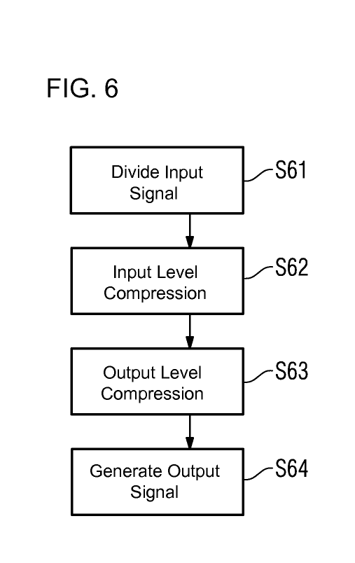

FIG. 6 shows a flowchart for performing an inventive method for signal processing in a hearing aid. In this case, in a first method step S61, an electrical input signal is divided into a plurality of frequency bands. Next, in a method step S62, input-level-controlled dynamic compression is performed in at least one first frequency band and in parallel therewith, in a method step S63, output-level-controlled dynamic compression is performed in at least one second frequency band before the differently processed signals are merged (added) into an output signal in a method step S64 and output.

1. A method for signal processing in a hearing aid, the method which comprises the following steps:
dividing an input signal into a plurality of frequency bands;
performing input-level-controlled dynamic compression in at least one first frequency band of the plurality of frequency bands;
performing output-level-controlled dynamic compression in at least one second frequency band of the plurality of frequency bands; and
outputting an output signal.

2. The method according to claim 1, which comprises splitting the first frequency band and/or the second frequency band into at least two parallel signal paths including a first signal path and a second signal path, and performing input-level-controlled dynamic compression in the first signal path and performing output-level-controlled dynamic compression in the second signal path.

3. The method according to claim 2, which comprises switching over between the first signal path and the second signal path in the first and/or the second frequency bands in order to generate an output signal of the respective frequency band.

4. The method according to claim 2, which comprises, following the dynamic compression, merging the signal paths in the first and/or second frequency bands in a specific mixing ratio.

5. The method according to claim 4, which comprises dividing each of the first frequency band and the second frequency band into two respective signal paths and setting the mixing ratio in the first frequency band to be different from the mixing ratio in the second frequency band.

6. The method according to claim 1, wherein the input-level-controlled dynamic compression is a Wide Dynamic Range Compression.

7. The method according to claim 1, wherein the output-level-controlled dynamic compression is an Adaptive Dynamic Range Optimization compression.

8. The method according to claim 1, which comprises performing output-level-controlled dynamic compression in at least one frequency band in a lower frequency range that can be transmitted by the hearing aid.

9. The method according to claim 1, which comprises performing input-level-controlled dynamic compression in at least one frequency band in an upper frequency range that can be transmitted by the hearing aid.

10. The method according to claim 1, which comprises programming the hearing aid to assign mutually different types of dynamic compression to individual frequency bands.

11. The method according to claim 1, which comprises assigning mutually different types of dynamic compression to individual frequency bands or adjusting the mixing ratio of the signal paths in at least one of the frequency bands as a function of a hearing situation with which the hearing aid is currently presented.

12. A hearing aid, comprising:
an input transducer for acquiring an acoustic input signal and converting the input signal into an electrical input signal;
a filter bank for dividing the electrical input signal into a plurality of frequency bands;
a device for performing output-level-controlled dynamic compression in at least one first frequency band of the plurality of frequency bands;
a device for performing input-level-controlled dynamic compression in at least one second frequency band of the plurality of frequency bands;
a merging device for merging output signals of the individual frequency bands into an overall electrical output signal; and
an output converter for converting the overall electrical output signal into an output signal to be perceived as an acoustic output signal by a user.

13. The hearing aid according to claim 12, configured to carry out the method according to claim 1.

14. The hearing aid according to claim 12, which comprises a splitter for splitting a signal path of at least one frequency band into two parallel signal paths including a first signal path and a second signal path, and which further comprises means for performing input-level-controlled dynamic compression in the first signal path and means for performing output-level-controlled dynamic compression in the second signal path.

15. The hearing aid according to claim 14, which further comprises for differently weighting and merging the signal paths.

16. The hearing aid according to claim 12, which further comprises a classification and control unit for detecting an acoustic hearing situation with which the hearing aid is currently presented, and for specifying a type of dynamic compression in at least one frequency band and/or for determining the weights of the individual signal paths.

17. The hearing aid according to claim 12, wherein the hearing aid is programmable for specifying an assignment of the different types of dynamic compression to the individual frequency bands.

18. The hearing aid according to claim 12, wherein an assignment of the different types of dynamic compression to the individual frequency bands and the mixing ratio of the signal paths in at least one frequency band is automatically adjustable in dependence on a hearing situation with which the hearing aid is currently presented.
